(19) United States
(12) Patent Application Publication
(10) Pub. No.: US 2011/0177256 A1
(43) Pub. Date: Jul. 21, 2011

(54) CURING PROCESS

(75) Inventors: T. Brian McAneney, Burlington (CA); Gordon Sisler, St. Catharines (CA); Michelle N. Chrétien, Mississauga (CA)

(73) Assignee: XEROX CORPORATION, Norwalk, CT (US)

(21) Appl. No.: 12/689,456

(22) Filed: Jan. 19, 2010

(51) Int. Cl. C08J 7/18

(52) U.S. Cl. 427/514; 427/520

(57) ABSTRACT

A process for overcoating an image and enhancing the adherence of the overcoat to the image by applying heat and/or infrared light to the image. The image may be formed with a toner containing a resin and colorant.

### BACKGROUND

The present disclosure relates to processes for overcoating and optionally hardening toner based electrophotographic images. These images, in embodiments, may be used with packaging media.

Numerous processes are within the purview of those skilled in the art for the preparation of toners. Emulsion aggregation (EA) is one such method. These toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

Ultraviolet curable toners, as well as overprint coatings for aiding in the retention of a toner image on a substrate, have been developed. For example, U.S. Pat. No. 5,275,918, the disclosure of which is hereby incorporated by reference in its entirety, discloses an ultraviolet curable heat activatable transfer toner, including (i) an ultraviolet curable, epoxy-containing, copolymer; (ii) a solid plasticizer; and (iii) a photoinitiator. Ultraviolet-hardenable overprint coatings include those disclosed in U.S. Pat. No. 6,713,222,

In general, adhesion failure can take several forms, often based on the extent to which the coating has been dried or cured. For example, surface tension and viscosity properties of the liquid film being applied may violate thermodynamic requirements for adhesion to a particular substrate, resulting in non-uniform wetting and leveling. In the field of overprint coatings for digital prints, a number of patents deal with this class of adhesion failure, including U.S. Pat. No. 7,166,406, the disclosure of which is hereby incorporated by reference in its entirety. Failure of the dried and/or cured film to adequately adhere to the substrate represents another class of adhesion failure.

Improved methods for applying and sealing images, including images onto packages, remain desirable.

### SUMMARY

In accordance with the present disclosure, methods are provided for improving the permanence of electrophotographic images. The process may include obtaining an image by a electrophotographic process, wherein the image is fused on the substrate by a contact or a non-contact fuser, followed by applying an overprint coating on the image, such as a coating including an ultraviolet initiator, and optionally an unsaturated monomer and vehicle, followed by subjecting the image and overcoat to heating with thermal radiation that may be supplied using an infrared light, and then curing the coating with an ultraviolet light, wherein the coating adhesion to the toner image is improved by the heating stage prior to the application of, ultraviolet light.

In embodiments, a process of the present disclosure may include applying an overprint coating including an ultraviolet initiator and unsaturated monomer to a substrate to form a coated substrate; heating the coated substrate; and applying ultraviolet light to the coated substrate.

In embodiments, a process of the present disclosure may include applying an overprint coating including an ultraviolet initiator and unsaturated monomer to a substrate to form a coated substrate; applying heat at a temperature of from about 70° C. to about 120° C. to the coated substrate; and applying ultraviolet light to the coated substrate. In embodiments, an image formed from a toner including a polyester resin, a colorant, and an optional wax, is applied to the substrate prior to applying the overprint coating.

In other embodiments, a process of the present disclosure may include applying a toner including a polyester resin, a colorant, and a wax to a substrate to form an image on the substrate; applying an overprint coating including an ultraviolet initiator to the image to obtain a coated image; heating the coated image at a temperature of from about 70° C. to about 120° C. for a period of time of from about 20 milliseconds to about 70 milliseconds; and applying ultraviolet light at a wavelength of from about 200 nm to about 500 nm to the coated image for a period of time of from about 10 milliseconds to about 50 milliseconds.

### DETAILED DESCRIPTION

The present disclosure provides processes for enhancing the permanence of a toner image to a substrate. Toners may include a wax, which enables the use of so-called oil-less fusers, i.e., fusing subsystems that do not require the application of a low surface energy fluid to ensure release at elevated temperature. However, one issue that may arise with wax-containing toners, including EA toners possessing a wax, is the wax in the toner may interfere with the adhesion between the cured overprint coating and the toner. It has been observed that cured overprint coatings, applied over electrophotographic images based on toners containing a wax, may be easily removed, for example by means such as a tape-pull test within the purview of those skilled in the art. This poor adhesion can result in problems with functional quality requirements.

The present disclosure provides processes to improve the permanence of printed images by the improved adhesion of transparent coating films, referred to herein, in embodiments, as an overprint coating or an overprint varnish, applied to images on a substrate. In embodiments, processes of the present disclosure may include applying an uncured ultraviolet-curable coating over an electrophotographic print produced with a wax-containing toner, followed by applying heat which may be provided by infrared light to the overcoating, to enhance adhesion of the coating. In embodiments, heating may be applied using any of a variety of radiant sources including, but not limited to, quartz lamp, pulsed infrared (IR), IR laser, other rapid heating sources, combinations thereof, and the like.

In accordance with the present disclosure, applying heat to a printed image following the application of a liquid overprint coating, but before curing such coating, substantially improves the adhesion of the cured film to the printed image, resulting in a marked improvement in quality and image permanence. The components of the UV curable overprint coatings plasticize toners, and the subsequent heating of the overcoating and underlying image increases the rate of toner plasticization by the overprint coating, thereby creating greater interaction between the two layers across the interface region, enhancing adhesion of the overcoat to the image, the substrate possessing the image, or both.

In embodiments, the underlying printed image may include digital prints made using an electrophotographic process.

Furthermore, the present disclosure may utilize overprint coatings that are solventless, sometimes referred to in embodiments as including 100% solids, which are curable coatings. Curing of these coatings may be provided by UV radiation, electron beam, or some other source of energy.

In some embodiments, the present disclosure includes a process wherein a low melting toner is utilized to generate an electrophotographic image, and wherein the electrophotographic image is overcoated with an overcoating that is exposed to thermal radiation, increasing the adhesion of the overcoating to the toner and the substrate, prior to any curing by ultraviolet light, thereby enhancing the permanence of the image produced by the toner on the substrate.

As noted above, in accordance with the present disclosure, an overprint coating including an ultraviolet initiator and an unsaturated monomer can be applied or coated onto an electrophotographic image, followed by the application of thermal radiation in the form of infrared light and/or heat, to enhance adherence of the overcoat to the image. In embodiments, the overcoat is then subjected to ultraviolet light or other form of energy to cure the polymer resulting in a hardened film enhancing image permanence.

Overprint coatings can be applied to the electrophotographic images prior to exposure to heat and/or infrared light, and prior to post curing with ultraviolet light. Examples of suitable overprint coating compositions include, in embodiments, coatings that are 100% solids, also known as solventless coatings. Such coatings may include reactive monomers, photoinitiators, combinations thereof, and the like, which may be cured by application of energy from ultraviolet radiation, electron beam, combinations thereof, and the like.

Examples of unsaturated monomers that can be utilized in the overprint coating include acrylates, such as methyl acrylate, methyl methacrylate, ethyl acrylate, ethyl methacrylate, propyl acrylate, propyl methacrylate, butyl acrylate, butyl methacrylate, hexyl acrylate, hexyl methacrylate, 2-phenoxylethyl acrylate, 2-phenoxylethyl methacrylate, caprolactone acrylate, isobornyl acrylate, isobornyl methacrylate, isodecylacryate, isooctylacrylate, tridecylacrylate, tridecylmethacrylate, 1,4-butanediol diacrylate, 1,4-butanediol dimethacrylate, 1,6-hexanediol diacryalte, 1,6-hexanediol dimethacrylate, alkoxylated hexanediol diacrylate, neopentyl glycol diacrylate, neopentyl glycol dimethacrylate, alkoxylated aliphatic diacrylate, alkoxylated neopentyl glycol diacrylate, tripropylene glycol diacrylate, propoxylated neopentyl glycol diacrylate, tricyclodecane dimethanol diacrylate, trimethylolpropane triacrylate, trimethyolpropane ethoxytriacrylate, combinations thereof, and the like. Such monomers may be present in an amount of from about 85 percent by weight to about 99 percent by weight of the overprint coating,

Examples of ultraviolet initiators that may be utilized in the overprint coating include, for example, photoinitiator materials which undergo fragmentation upon irradiation, hydrogen abstraction type initiators, and donor-acceptor complexes. Suitable photofragmentaion initiators include, but are not limited to, benzoin ethers, acetophenone derivatives such as 2,2-dimethoxy-2-phenyl acetophenone, 2-hydroxy-2-methyl-1-phenylpropan-1-one, 2,2,2-trichloroacetophenone, combinations thereof, and the like. Suitable hydrogen abstraction type initiators include benzophenones and derivatives thereof, anthraquinone, 4,4′-bis(dimethylamino)benzophenone (Michler's ketone), combinations thereof, and the like. Suitable donor-acceptor complexes include combinations of donors, such as triethanolamine, with acceptors such, as benzophenone. Also suitable are sensitizers or initiators such as thioxanthone with quinoline sulfonylchloride; 2,4,6-trimethylbenzoyl diphenylphosphine oxide, (2-methyl-1-[4-(methylthio)phenyl]-2-morpholinopropane-1-one), (hydroxycyclohexyl)phenyl ketone, (2-benzyl-2-N-dimethylamino-1-(4-morpholinophenyl)-1-butanone), (benzyl dimethyl ketal), 2-(carbamoylazo)-substituted, 2-n-propoxy-9H-thioxanthen-9-one, ethyl 4-(dimethylamino)benzoate, combinations thereof, and the like.

The photoinitiator may be present in an overprint coating in a suitable amount of from about 0.25 percent by weight to about 15 percent by weight of the overprint coating, in embodiments from about 0.5 percent by weight to about 10 percent by weight of the overprint coating, in other embodiments from about 1 percent by weight to about 5 percent by weight of the overprint coating.

The photoinitiators may respond to light (ultraviolet or visible) with wavelengths of, for example, from about 250 nanometers to about 550 nanometers, in embodiments from about 320 nanometers to about 500.

The overprint coating may be applied to provide a coating having a thickness of from about 1 micron to about 5 microns, in embodiments from about 2 microns to about 4 microns.

### Resins

Any toner resin may be utilized in the processes of the present disclosure. Such resins, in turn, may be made of any suitable monomer or monomers via any suitable polymerization method. In embodiments, the resin may be prepared by a method such as emulsion polymerization. In embodiments, the resin may be prepared by a method other than emulsion polymerization. In further embodiments, the resin may be prepared by condensation polymerization.

In embodiments, the resin may be a polyester, polyimide, polyolefin, polyamide, polycarbonate, epoxy resin, and/or copolymers thereof. In embodiments, the resin may be an amorphous resin, a crystalline resin, and/or a mixture of crystalline and amorphous resins. The crystalline resin may be present in the mixture of crystalline and amorphous resins, for example, in an amount of from 0 to about 50 percent by weight of the total toner resin, in embodiments from 5 to about 35 percent by weight of the toner resin. The amorphous resin may be present in the mixture, for example, in an amount of from about 50 to about 100 percent by weight of the total toner resin, in embodiments from 95 to about 65 percent by weight of the toner resin. In embodiments, the resin may be a polyester crystalline and/or a polyester amorphous resin.

In embodiments, the polymer utilized to form the resin may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. The crystalline resin may be present, for example, in an amount of from about 5 to about 50 percent by weight of the toner components, in embodiments from about 10 to about 35 percent by weight of the toner components.

The crystalline resin can possess various melting points of, for example, from about 30° C. to about 120° C., in embodiments from about 50° C. to about 90° C. The crystalline resin may have a number average molecular weight (Mn), as measured by gel permeation chromatography (GPC) of, for example, from about 1,000 to about 50,000, in embodiments from about 2,000 to about 25,000, and a weight average molecular weight (Mw) of, for example, from about 2,000 to about 100,000, in embodiments from about 3,000 to about 80,000, as determined by Gel Permeation Chromatography using polystyrene standards. The molecular weight distribution (Mw/Mn) of the crystalline resin may be, for example, from about 2 to about 6, in embodiments from about 3 to about 4. Suitable crystalline resins which may be utilized, optionally in combination with an amorphous resin, include those disclosed in U.S. Patent Application Publication No. 2006/0222991, the disclosure of which is hereby incorporated by reference in its entirety. Such crystalline resins may have a weight average molecular weight (Mw) of from about 10,000 to about 100,000.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. In embodiments, an unsaturated, amorphous polyester resin may be utilized as a latex resin. Examples of such resins and processes for their production include those disclosed in U.S. Pat. No. 6,063,827, the disclosure of which is hereby incorporated by reference in its entirety.

The amorphous resin can possess various glass transition temperatures (Tg) of, for example, from about 40° C. to about 100° C., in embodiments from about 50° C. to about 70° C. The amorphous resin may have a number average molecular weight (Mₙ), for example, from about 1,000 to about 50,000, in embodiments from about 2,000 to about 25,000, and a weight average molecular weight (M_{w}) of, for example, from about 2,000 to about 100,000, in embodiments from about 3,000 to about 80,000, as determined by Gel Permeation Chromatography (GPC) using polystyrene standards. The molecular weight distribution (M_{w}/Mₙ) of the amorphous resin may be, for example, from about 2 to about 6, in embodiments from about 3 to about 4. Such amorphous resins may have a weight average molecular weight (Mw) of from about 10,000 to about 100,000.

Examples of other suitable toner resins or polymers which may be utilized include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), polystyrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), and poly(styrene-butyl acrylate-acrylonitrile-acrylic acid), and combinations thereof. The polymer may be block, random, or alternating copolymers.

One, two, or more toner resins may be used. In embodiments where two or more toner resins are used, the toner resins may be in any suitable ratio (e.g., weight ratio) such as for instance about 10% (first resin)/90% (second resin) to about 90% (first resin)/10% (second resin).

In embodiments, the resin utilized may possess some degree of unsaturation, thereby further enhancing its crosslinking upon exposure to ultraviolet light.

### Colorants

As the colorant to be added, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 20 weight percent of the toner, or from about 3 to about 15 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP608™; Magnox magnetites TMB-100™, or TMB-104™; and the like. As colored pigments, there can be selected cyan, magenta, yellow, red, green, orange, violet, brown, blue, red, purple, white, silver, or combinations thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido)phthalocyanine, x-copper phthalocyanine pigment listed in the Color Index as CI 74160, CI Pigment Blue, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be included with the resin emulsion, or combined with the resin and a colorant in forming toner particles. When included, the wax may be present in an amount of, for example, from about 1 weight percent to about 30 weight percent of the toner particles, in embodiments from about 5 weight percent to about 25 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures of waxes may also be used. Waxes may be included as, for example, fuser roll release agents.

### Aggregation and Coalescence

In embodiments, toners may be prepared by a process that includes aggregating a mixture of a resin, a colorant, optionally a wax and any other desired or required additives, and then optionally coalescing the aggregated particles. Examples of such processes include those disclosed in U.S. Pat. Nos. 5,403,693, 5,418,108, 5,364,729, 5,346,797, 5,527,658, 5,585,215, 5,650,255, 5,650,256 and 5,501,935, the disclosures of each of which are hereby incorporated by reference in their entirety.

### Additives

In embodiments, the toner particles may also contain other optional additives, as desired or required. For example, the toner may include positive or negative charge control agents, for example in an amount of from about 0.1 to about 10 percent by weight of the toner, in embodiments from about 1 to about 3 percent by weight of the toner. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E84™ or E88™ (Hodogaya Chemical); combinations thereof, and the like.

There can also be blended with the toner particles external additive particles including flow aid additives, which additives may be present on the surface of the toner particles. Examples of these additives include metal oxides such as titanium oxide, silicon oxide, tin oxide, mixtures thereof, and the like; colloidal silicas, such as AEROSIL®, metal salts and metal salts of fatty acids inclusive of zinc stearate, aluminum oxides, cerium oxides, and mixtures thereof. Each of these external additives may be present in an amount of from about 0.1 percent by weight to about 5 percent by weight of the toner, in embodiments of from about 0.25 percent by weight to about 1 percent by weight of the toner. Suitable additives include those disclosed in U.S. Pat. Nos. 3,590,000, 3,800,588, and 6,214,507, the disclosures of each of which are hereby incorporated by reference in their entirety.

### Developers

The toner particles may be formulated into a developer composition. The toner particles may be mixed with carrier particles to achieve a two-component developer composition. The toner concentration in the developer may be from about 1% to about 25% by weight of the total weight of the developer, in embodiments from about 2% to about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrophotographic processes, including those disclosed in U.S. Pat. No. 4,265,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with a electrophotographic device including a charging component, an imaging component, a photoconductive component, a developing component, a transfer component, and a fusing component. In embodiments, the imaging system may utilize oil-less fusers. In embodiments, the development component may include a developer prepared by mixing a carrier with a toner composition described herein. The electrophotographic device may include a high speed printer, a black and white high speed printer, a color printer, and the like.

Once the image is formed with toners/developers via a suitable image development method such as any one of the aforementioned methods, the image may then be transferred to an image receiving medium, which may be referred to, in embodiments, as a substrate. Substrates to which images may be applied include, for example, papers including coated papers, and synthetic films such as MYLAR®, aluminum foil, combinations thereof, and the like, which are suitable for radiation curable coatings. Papers may be made of chemical and/or mechanical pulps, and the like.

In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium, i.e., substrate. In other embodiments, non-contact fusing may be utilized to fuse the toner to the substrate. In embodiments, the fuser member may be heated to a temperature above the fusing temperature of the toner, for example to temperatures of from about 70° C. to about 210° C., in embodiments from about 80° C. to about 205° C., in other embodiments from about 90° C. to about 200° C., after or during melting onto the image receiving substrate.

### Overprint Coating

In embodiments, the application of the overprint coating may be from a liquid film applicator device, which may possess 2 or more rolls, including forward and/or reverse, as well as offset rolls such as anilox flex, direct gravure, screen, combinations thereof, and the like.

The coating may be applied in-line, i.e., within 3 seconds of fusing, as well as near-line or off-line, meaning an indefinite period after fusing. In accordance with the present disclosure, the relevance of the time delay between fusing and coating application is primarily in regards to the amount of heat that should be applied to achieve the desired adherence found as described above with the methods of the present disclosure.

Following the application of the liquid film coating, the uncured coated print is subjected to rapid heating using a source of thermal radiation such as quartz glass IR emitter lamps, but which may also be pulsed IR, IR laser, or other source, to heat the interface between the coating and toner image. The monomers used in the coatings as described above plasticize the toner, so that the coatings increase the rate of plasticization kinetics to improve adhesion by increasing the interaction across the interface region between the overprint coating and the toner.

The process is such that the contact angle of the coating liquid on the toner, measured by standard methods of sessile drop shape analysis over the first half second after drop application, may decrease to less than 22-24°, in embodiments less than 22°, in embodiments from about 16 to about 22°, compared with contact angles in excess of 25° utilized with other overprint coatings. The reduction in contact angle is indicative of the increased interaction between the coating and the fused toner image, and is also indicative of the increased rate of plasticization.

In accordance with the present disclosure, after image printing, but prior to the application of ultraviolet radiation, the overprint coating is heated to a temperature of from about 70° C. to about 120° C., in embodiments from about 75° C. to about 110° C., for a period of time of from about 20 milliseconds (ms) to about 70 ms, in embodiments from about 30 ms to about 60 ms.

After the above heating through exposure to thermal radiation, the overprint coating is subjected to ultraviolet radiation at a wavelength of from about 200 nm to about 500 nm, in embodiments from about 250 nm to about 450 nm, for a period of time of for about less than 1 second, in embodiments from about 10 ms to about 50 ms.

The benefits described above may be confirmed using versions of the tape-pull test, which is within the purview of those skilled in the art. In accordance with the present disclosure, applying heat after coating but before curing may result in images where the tape pull removal decreases to 0%, compared with images not subjected to the heating step, where 100% of a cured coating film can be removed with the tape pull.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

Images for coating were made with a Xerox DC250 on 210 gsm Xerox Digital Color Elite Gloss paper. The images were made with a toner based upon a styrene/butyl acrylate/beta-carboxyethyl acrylate resin commercially available from Xerox Corporation. A solid black rectangle was utilized as the image and the media was run with the fuser on the Heavy weight (HW2) (“HW2”) setting. There was a delay of about 48 hours between application of the images with fusing and the subsequent overcoating with an overprint coating.

A commercial UV coating, Fuji Hunt Ultracoat UV X2 (from Fuji Xerox), was applied with a Euclid lab coater configured with a 220 lpi/7.5 BCM gravure roll which transferred the coating to an EPDM rubber roll and then to the printed image (lpi is often referred to as ‘line screen’ and means, in embodiments, the number of cells per linear inch engraved in gravure or anilox rolls used for printing or coating; BCM is a unit describing cell volume per unit area in engraved gravure or anilox rolls and means, in embodiments, billion cubic microns per square inch). The coated sheet was hand fed from the Euclid to a Fusion UV curing station, with a lay down period of about 5 seconds.

Two quartz glass IR emitter lamps (carbon plus short wave length twin tube) supplied by Heraeus, were positioned over the belt conveyor of a FusionUV station, immediately prior to the sheet passing under the UV lamps. A voltage varying between 60 and 118 volts was supplied to the IR lamps and the belt conveyor speed was fixed at about 90 feet/minute.

A control sample was prepared with the same image/overcoat, but no IR treatment.

An additional laydown period of about 1 minute occurred between applying the coating and placing the coated image on the FusionUV conveyor, i.e. before either the IR or UV lamp.

After curing, the coated prints were allowed to equilibrate to room temperature before testing. A tape test was performed using a designated roll of 3M Scotch® Magic™ Tape 810D, ¾″ wide. Five separate, parallel strips of tape were placed across the coated image and firmly pressed down several times by hand to affix to the surface, then stripped at an approximately constant acute peel angle of about 45° using a uniform peel speed. To assure uniformity of adhesion and peel conditions, one individual performed the test every time; this was checked by comparison with two other individual peel testers whose test procedure (adhesion pressure, peel speed, etc) varied; results were similar across all the 3 testers.

A summary of the process of the present disclosure, including exposure to the IR lamp and tape test results, are set forth below in Table 1.

TABLE 1

| | | | Tape Test | |
|---|---|---|---|---|
| | Extended | IR | % coating removed | |
| Coating | Laydown | Lamp | (visual estimate) | Other Observations |
| Fuji Hunt | none | none | 65% coating | no gloss disturbance |
| Ultracoat UV | | | removal | |
| X2 | | | | |
| Fuji Hunt | 1 minute | none | 0% coating | no gloss disturbance |
| Ultracoat UV | | | removal | |
| X2 | | | | |
| Fuji Hunt | none | 118 V | 0% coating | no coating removed but |
| Ultracoat UV | | | removal | gloss disturbance when |
| X2 | | | | tape removed plus belt |
| | | | | pattern visible (too much |
| | | | | heat) |
| Fuji Hunt | 1 minute | 118 V | 0% coating | no coating removed but |
| Ultracoat UV | | | removal | gloss disturbance when |
| X2 | | | | tape removed plus belt |
| | | | | pattern visible (too much |
| | | | | heat) |
| Fuji Hunt | none | 60 V | 6% coating | no gloss disturbance |
| Ultracoat UV | | | removal | |
| X2 | | | | |
| Fuji Hunt | none | 60 V | 0% coating | no gloss disturbance |
| Ultracoat UV | | | removal | |
| X2 | | | | |

As can be seen from Table 1, the additional heat supplied by the IR lamp to the coated film prior to curing achieved the same improvement in coating adhesion as extended laydown. It was also observed that excess heat (118V) resulted in gloss disturbance defects, but that there was a window where additional heat provided adhesion without compromising print quality.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A process comprising:
applying an overprint coating comprising an ultraviolet initiator in combination with an unsaturated monomer to a substrate to form a coated substrate;
heating the coated substrate; and
applying ultraviolet light to the coated substrate.

2. The process according to claim 1, wherein the ultraviolet initiator is selected from the group consisting of 2,2-dimethoxy-2-phenyl acetophenone, 2-hydroxy-2-methyl-1-phenylpropan-1-one, 2,2,2-trichloroacetophenone, anthraquinone, benzophenone, 4,4′-bis(dimethylamino)benzophenone, thioxanthone with quinoline sulfonylchloride, 2,4,6-trimethylbenzoyl-diphenyl-phosphine oxide, (2-methyl-1-[4-(methylthio)phenyl]-2-morpholinopropane-1-one), (hydroxycyclohexyl)phenyl ketone, (2-benzyl-2-N-dimethylamino-1-(4-morpholinophenyl)-1-butanone), (benzyl dimethyl ketal), 2-(carbamoylazo)-substituted, 2-n-propoxy-9H-thioxanthen-9-one, ethyl 4-(dimethylamino)benzoate, and combinations thereof, present in an amount of from about 0.25 percent by weight to about 15 percent by weight of the overprint coating.

3. The process according to claim 1, wherein the unsaturated monomer is selected from the group consisting of methyl acrylate, methyl methacrylate, ethyl acrylate, ethyl methacrylate, propyl acrylate, propyl methacrylate, butyl acrylate, butyl methacrylate, hexyl acrylate, hexyl methacrylate, 2-phenoxylethyl acrylate, 2-phenoxylethyl methacrylate, caprolactone acrylate, isobornyl acrylate, isobornyl methacrylate, isodecylacryate, isooctylacrylate, tridecylacrylate, tridecylmethacrylate, 1,4-butanediol diacrylate, 1,4-butanediol dimethacrylate, 1,6-hexanediol diacryalte, 1,6-hexanediol dimethacrylate, alkoxylated hexanediol diacrylate, neopentyl glycol diacrylate, neopentyl glycol dimethacrylate, alkoxylated aliphatic diacrylate, alkoxylated neopentyl glycol diacrylate, tripropylene glycol diacrylate, propoxylated neopentyl glycol diacrylate, tricyclodecane dimethanol diacrylate, trimethylolpropane triacrylate, trimethyolpropane ethoxytriacrylate, and combinations thereof.

4. The process according to claim 1, wherein heating the coated substrate occurs at a temperature at from about 70° C. to about 120° C., for a period of time of from about 20 milliseconds to about 70 milliseconds.

5. The process according to claim 1, wherein the ultraviolet light is applied at a wavelength of from about 200 nm to about 500 nm for a period of time of from about 10 milliseconds to about 50 milliseconds.

6. The process according to claim 1, wherein an image formed from a toner comprising a polyester resin, a colorant, and an optional wax, is applied to the substrate prior to applying the overprint coating.

7. The process according to claim 6, wherein the resin is selected from the group consisting of amorphous polyester resins, crystalline polyester resins, and combinations thereof, wherein the colorant is a pigment selected from the group consisting of black, cyan, magenta, yellow, green, orange, violet, blue, red, purple, white, silver, and combinations thereof, and wherein the wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 30 weight percent of the toner.

8. The process according to claim 7 wherein the resin comprises a crystalline polyester having a number average molecular weight of from about 1,000 to about 50,000, a weight average molecular weight of from about 2,000 to about 100,000, and a molecular weight distribution (Mw/Mn) of from about 2 to about 6.

9. A process comprising:
applying an overprint coating comprising an ultraviolet initiator in combination with an unsaturated monomer to a substrate to form a coated substrate;
applying heat at a temperature of from about 70° C. to about 120° C. to the coated substrate; and
applying ultraviolet light to the coated substrate.

10. The process according to claim 9, wherein the ultraviolet initiator is selected from the group consisting of 2,2-dimethoxy-2-phenyl acetophenone, 2-hydroxy-2-methyl-1-phenylpropan-1-one, 2,2,2-trichloroacetophenone, anthraquinone, benzophenone, 4,4′-bis(dimethylamino)benzophenone, thioxanthone with quinoline sulfonylchloride, 2,4,6-trimethylbenzoyl-diphenyl-phosphine oxide, (2-methyl-1-[4-(methylthio)phenyl]-2-morpholinopropane-1-one), (hydroxycyclohexyl)phenyl ketone, (2-benzyl-2-N-dimethylamino-1-(4-morpholinophenyl)-1-butanone), (benzyl dimethyl ketal), 2-(carbamoylazo)-substituted, 2-n-propoxy-9H-thioxanthen-9-one, ethyl 4-(dimethylamino)benzoate, and combinations thereof, present in an amount of from about 0.25 percent by weight to about 15 percent by weight of the overprint coating.

11. The process according to claim 9, wherein the unsaturated monomer is selected from the group consisting of methyl acrylate, methyl methacrylate, ethyl acrylate, ethyl methacrylate, propyl acrylate, propyl methacrylate, butyl acrylate, butyl methacrylate, hexyl acrylate, hexyl methacrylate, 2-phenoxylethyl acrylate, 2-phenoxylethyl methacrylate, caprolactone acrylate, isobomyl acrylate, isobomyl methacrylate, isodecylacryate, isooctylacrylate, tridecylacrylate, tridecylmethacrylate, 1,4-butanediol diacrylate, 1,4-butanediol dimethacrylate, 1,6-hexanediol diacryalte, 1,6-hexanediol dimethacrylate, alkoxylated hexanediol diacrylate, neopentyl glycol diacrylate, neopentyl glycol dimethacrylate, alkoxylated aliphatic diacrylate, alkoxylated neopentyl glycol diacrylate, tripropylene glycol diacrylate, propoxylated neopentyl glycol diacrylate, tricyclodecane dimethanol diacrylate, trimethylolpropane triacrylate, trimethyolpropane ethoxytriacrylate, and combinations thereof.

12. The process according to claim 9, wherein the heat is applied for a period of time of from about 20 milliseconds to about 70 milliseconds.

13. The process according to claim 9, wherein the ultraviolet light is applied at a wavelength of from about 200 nm to about 500 nm for a period of time of from about 10 milliseconds to about 50 milliseconds.

14. The process according to claim 9, wherein an image formed from a toner comprising a polyester resin, a colorant, and an optional wax, is applied to the substrate prior to applying the overprint coating.

15. The process according to claim 14, wherein the resin is selected from the group consisting of amorphous polyester resins, crystalline polyester resins, and combinations thereof, wherein the colorant is a pigment selected from the group consisting of black, cyan, magenta, yellow, green, orange, violet, blue, red, purple, white, silver, and combinations thereof, and wherein the wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 30 weight percent of the toner.

16. The process according to claim 14, wherein the resin comprises a crystalline polyester having a number average molecular weight of from about 1,000 to about 50,000, a weight average molecular weight of from about 2,000 to about 100,000, and a molecular weight distribution (Mw/Mn) of from about 2 to about 6.

17. A process comprising:
applying a toner comprising a polyester resin, a colorant, and a wax to a substrate to form an image on the substrate;
applying an overprint coating including an ultraviolet initiator to the image to obtain a coated image;
heating the coated image at a temperature of from about 70° C. to about 120° C. for a period of time of from about 20 milliseconds to about 70 milliseconds; and
applying ultraviolet light at a wavelength of from about 200 nm to about 500 nm to the coated image for a period of time of from about 10 milliseconds to about 50 milliseconds.

18. The process according to claim 17, wherein the polyester resin is selected from the group consisting of amorphous polyester resins, crystalline polyester resins, and combinations thereof, the colorant is a pigment selected from the group consisting of black, cyan, magenta, yellow, green, orange, violet, blue, red, purple, white, silver, and combinations thereof, and the wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof.

19. The process according to claim 17, wherein the resin comprises a crystalline polyester having a number average molecular weight of from about 1,000 to about 50,000, a weight average molecular weight of from about 2,000 to about 100,000, and a molecular weight distribution (Mw/Mn) of from about 2 to about 6.

20. The process according to claim 17, wherein the ultraviolet initiator is selected from the group consisting of 2,2-dimethoxy-2-phenyl acetophenone, 2-hydroxy-2-methyl-1-phenylpropan-1-one, 2,2,2-trichloroacetophenone, anthraquinone, benzophenone, 4,4′-bis(dimethylamino)benzophenone, thioxanthone with quinoline sulfonylchloride, 2,4,6-trimethylbenzoyl-diphenyl-phosphine oxide, (2-methyl-1-[4-(methylthio)phenyl]-2-morpholinopropane-1-one), (hydroxycyclohexyl)phenyl ketone, (2-benzyl-2-N-dimethylamino-1-(4-morpholinophenyl)-1-butanone), (benzyl dimethyl ketal), 2-(carbamoylazo)-substituted, 2-n-propoxy-9H-thioxanthen-9-one, ethyl 4-(dimethylamino)benzoate, and combinations thereof, present in an amount of from about 0.25 percent by weight to about 15 percent by weight of the overprint coating.
